(19) United States
(12) Patent Application Publication
(10) Pub. No.: US 2013/0147632 A1
(43) Pub. Date: Jun. 13, 2013

(54) INDICATOR LIGHT CONTROL CIRCUIT

(71) Applicants: YI-XIN TU, Shenzhen City (CN); JIN-LIANG XIONG, Shenzhen City (CN); HAI-QING ZHOU, Shenzhen City (CN)

(72) Inventors: YI-XIN TU, Shenzhen City (CN); JIN-LIANG XIONG, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/587,862

(22) Filed: Aug. 16, 2012

(30) Foreign Application Priority Data
Dec. 9, 2011 (CN) 201110408501.X

(51) Int. Cl. G08B 5/36

(52) U.S. Cl. 340/815.45; 340/815.4

(57) ABSTRACT

An indicator light control circuit for controlling a single indicator light to indicate a high or low link speed of a network connection includes a pulse signal generating circuit, a bias circuit having a digital potentiometer, and a controller. The pulse signal generating circuit generates a pulse signal. The digital potentiometer is electronically connected to the pulse signal generating circuit and the controller. The controller adjusts the effective resistance of the digital potentiometer connected to the pulse signal generating circuit according to different link speeds being experienced in the network connection, to adjust a duty cycle of the pulse signal, thereby changing the on-time and off-time of the indicator light.

### BACKGROUND

1. Technical Field

The exemplary disclosure generally relates to control circuits, particularly to an indictor light control circuit for controlling operation of indictor lights.

2. Description of Related Art

Computers, servers, and network hosts usually have three indicator lights to monitor and inform concerning the status of the network: a network link indicator light, a 10M/100M link speed indicator light and a 1000M link speed indicator light. When the network works at a 10M/100M link speed or at a 1000M link speed, the corresponding link speed indictor light blinks. In other words, two indicator lights are needed to indicate two different link speeds, which will add complexity to the device and spoil a simple appearance.

Therefore, there is room for improvement within the art.

### BRIEF DESCRIPTION OF THE DRAWINGS

Many aspects of the embodiments can be better understood with reference to the drawings. In the drawings, the emphasis is placed upon clearly illustrating the principles of the disclosure.

FIG. 1 is a block diagram of an exemplary embodiment of an indicator light control circuit.

FIG. 2 is a schematic circuit diagram of the indicator light control circuit shown in FIG. 1.

### DETAILED DESCRIPTION

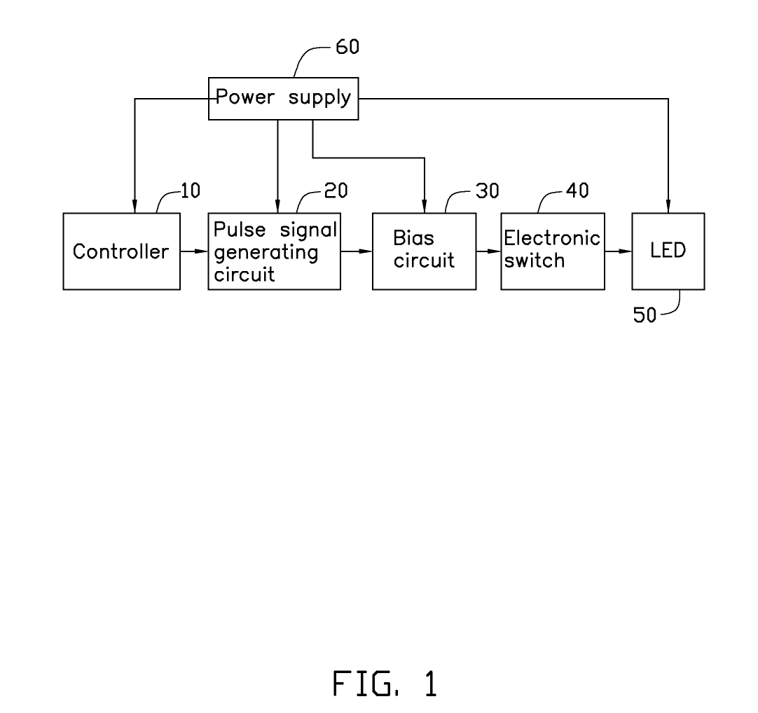

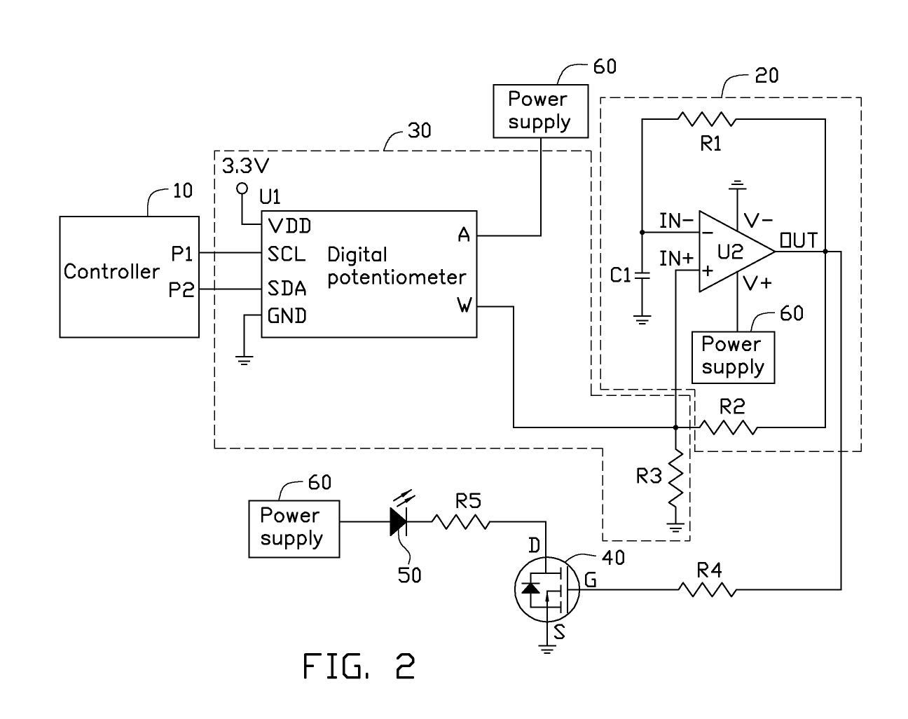

FIG. 1 is a block diagram of an exemplary embodiment of an indicator light control circuit. The indicator light control circuit 100 includes a controller 10, a pulse signal generating circuit 20, a bias circuit 30, an electronic switch 40, a indicator light 50 and a power supply 60. The pulse signal generating circuit 20 generates and outputs a pulse signal to make the indicator light 50 blink. The bias circuit 30 includes a digital potentiometer U1 (shown in FIG. 2) electronically connected to the pulse signal generating circuit 20. The controller 10 changes a duty cycle of the pulse signal by changing an effective resistance of the digital potentiometer U1, thereby changing the time-on and the time-off of the indicator light 50. The power supply 40 powers the controller 10, the pulse signal generator circuit 20, the electronic switch 40 and the indicator light 50. In one embodiment, an output voltage of the power supply 60 is 5 volts.

FIG. 2 is a schematic circuit diagram of the indicator light control circuit shown in FIG. 1. The controller 10 includes a first control pin P1 and a second control pin P2, both of which are electronically connected to the digital potentiometer U1. The controller 10 communicates serially with the digital potentiometer U1 via the first control pin P1 and the second control pin P2, and drives the digital potentiometer U1 to change the effective resistance which is presented to the pulse signal generating circuit 20.

The pulse signal generating circuit 20 includes a comparator U2, an integral resistor R1, an integral capacitor C1, and a feedback resistor R2. The integral resistor R1 and the integral capacitor C1 cooperatively form a RC integral circuit. The comparator U2 has a non-inverting input terminal IN+, an inverting input terminal IN−, an output terminal OUT, a positive power pin V+, and a negative power pin V−. In the exemplary embodiment, the negative power pin V− is grounded, and the positive power pin V+ is electronically connected to the power supply 60. The integral resistor R1 is electronically connected between the output terminal OUT and the inverting input terminal IN− of the comparator U2. The integral capacitor C1 is electronically connected between ground and a node formed between the integral resistor R1 and the non-inverting input pin IN−. The feedback resistor R2 is electronically connected between the non-inverting input terminal IN+ and the output terminal OUT of the comparator U2. A node between the feedback resistor R2 and the non-inverting input terminal IN+ is electronically connected to the power supply 60 via the bias circuit 30.

The bias circuit 30 further includes a voltage dividing resistor R3. The voltage dividing resistor R3 and the digital potentiometer U1 are electronically connected in series between ground and the power supply 60, and a node between the voltage dividing resistor R3 and the digital potentiometer U1 is electronically connected to the node between the feedback resistor R2 and the non-inverting input terminal IN+. The digital potentiometer U1 has a power pin VDD, a clock pin SCL, a data pin SDA, a ground pin GND, a connecting pin A and a wiper pin W. The power pin VDD is electronically connected to a power supply to receive a 3.3V voltage. The clock pin SCL and the data pin SDA are electronically connected to the first and second control pins P1 and P2 respectively of the controller 10, and communicate serially with the controller 10. The ground pin GND is grounded. The connecting pin A is electronically connected to the power supply 60; the wiper pin W is electronically connected to the voltage dividing resistor R3. The digital potentiometer U1 is substantially a variable resistor, the effective resistance can be adjusted under the control of the controller 10.

When the comparator U2 is working, the power supply 60 powers the non-inverting input terminal IN+ of the comparator U2 via the digital potentiometer U1. A voltage of the non-inverting input terminal IN+ at this time is set as V1, and a voltage of the integral capacitor C1 is 0 volts, thus output terminal OUT of the comparator U2 outputs a voltage which approximately equals the voltage of the positive power terminal V+, that is, a high level voltage (+5V). At this time, the output terminal OUT charges the integral capacitor C1 via the integral resistor R1, and the voltage of the output terminal OUT is supplied to the non-inverting input terminal IN+ via the feedback resistor R2, to immediately pull-up the voltage of the non-inverting input terminal IN+ to a higher voltage, set as V2. The voltage V2 is higher than the voltage V1, while it is lower than the voltage of the positive power terminal V+. When the voltage of the integral capacitor C1 is increased beyond the voltage V2, the output terminal OUT of the comparator U2 outputs a voltage which approximately equals the voltage of the negative power terminal V−, that is, a low level voltage (0V). At this time, the voltage of the non-inverting input terminal IN+ returns to V1, and the integral capacitor C1 begins to discharge via the integral resistor R1, and the voltage of the integral capacitor C1 gradually decreases from voltage V2 to voltage V1. When the voltage of the integral capacitor C1 goes lower than the voltage V1, the comparator U2 outputs a high level voltage again, and the integral capacitor C1 is charged again.

In this way, the voltage of the non-inverting input terminal IN+ is alternately higher and lower than the voltage of the non-inverting terminal IN−, and thus the output terminal OUT generates a variable voltage which alternates between a high level voltage and a low level voltage, such as +5V and 0V, and it is the pulse signal which is fed to the electronic switch 40 to control the indicator light 50 to blink. The comparator U2 outputs pulse signals with different frequencies by setting different capacitances of the integral capacitor C1 and setting different resistances of the integral resistor R1, to produce different frequencies of flicker to the indicator light 50, and outputs pulse signals with different duty cycles by setting different resistances of the voltage dividing resistor R3, the feedback resistor R2, and the digital potentiometer U1, to set different time-on and time-off periods to the indicator light 50.

According to the inherent charging characteristics of the integral capacitor C1, the higher the voltage of the integral capacitor C1, the slower the charging speed and the faster the discharging speed. Therefore, in the exemplary embodiment, the smaller the effective resistance of the digital potentiometer U1, the higher the voltage (that is, voltages V1 and V2) of the non-inverting input terminal IN+, causing the capacitor C1 to spend a longer time being charged from voltage V1 to voltage V2, and thus increase the duration of the high level voltage outputted from the comparator U2. Accordingly, the capacitor C1 spends a shorter time discharging from voltage V2 to voltage V1, to make the duration of a low level voltage outputted from the comparator U2 briefer. At this time, the pulse signal has a higher duty cycle, while the frequency of the pulse signal is unchanged. Thus, the controller 10 can change the on-time and off-time of the indicator light 50 by adjusting an effective resistance of the digital potentiometer U1 when it is connected between the power supply 60 and the voltage dividing resistor R3.

The electronic switch 40 turns on or off under the control of the pulse signal, to turn on or off a current path between the power supply 60 and the indicator light 50, thereby alternately providing and not providing power to make the indicator light 50 flash. In the exemplary embodiment, the electronic switch 30 is an N channel metal-oxide-semiconductor field-effect transistor (MOSFET), the indicator light 50 is a light emitting diode (LED). A gate G of the N channel MOSFET is electronically connected to the output terminal OUT of the comparator U2 via a first current limiting resistor R4, a drain D of the N channel MOSFET is electronically connected to a cathode of the LED via a second current limiting resistor R5, and a source S of the N-channel MOSFET is grounded. An anode of the indicator light 50 is electronically connected to the power supply 50. When a voltage of the gate G is high, the N-channel MOSFET turns on, and the indicator light 50 is powered by the power supply 60 to illuminate. Alternatively, when the voltage of the gate G is low, the N-channel MOSFET turns off, and the power is cut off from the indicator light 50. The electronic switch 40 can be a NPN type bipolar junction transistor (BJT), of which the base, the emitter and the collector have electronic connections corresponding to those of the gate G, the source S and the drain D of the N channel MOSFET.

The indicator light control circuit 100 can be used in a network host (not shown). When the indicator light control circuit 100 is working, the controller 10 adjusts the effective resistance of the digital potentiometer U1 according to the working state of the computer. For example, when a link speed of the network host is 10M/100M, the controller 10 controls the digital potentiometer U1 to set a small effective resistance, to make the comparator U2 output a pulse signal having a higher duty cycle, so the indicator light 50 has a longer illumination time and a shorter off time in the blinking cycle. Alternatively, when the link speed of the network host is 1000M, the controller 10 controls the digital potentiometer U1 set a bigger effective resistance, to make the comparator U2 output a pulse signal having a lower duty cycle, so the indicator light 50 has a shorter illumination time and a longer off time in the blinking cycle. Therefore, a user can see the a link speed of the network host by means of only one indicator light 50, which reduces complexity and gives the network host a cleaner and simpler appearance.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An indicator light control circuit for controlling an indicator light, comprising:
a pulse signal generating circuit for generating a pulse signal;
a bias circuit comprising a digital potentiometer electronically connected to the pulse signal generating circuit;
a controller electronically connected to the digital potentiometer, the controller adjusting an effective resistance of the digital potentiometer connected to the pulse signal generating circuit, to adjust a duty cycle of the pulse signal correspondingly, thereby changing the on-time and off-time of the indicator light.

2. The indicator light control circuit as claimed in claim 1, further comprising a power supply, wherein the pulse signal generating circuit comprising a comparator, a integral resistor, a integral capacitor and a feedback resistor, the comparator comprising an inverting input terminal, a non-inverting input terminal, and an output terminal, the integral resistor is electronically connected between the output terminal and the inverting input terminal of the comparator, the integral capacitor is electronically connected between ground and a node between the integral resistor and the inverting input terminal, the feedback resistor is electronically connected between the non-inverting input terminal and the output terminal, the non-inverting input terminal is further electronically connected to the power supply via the bias circuit.

3. The indicator light control circuit as claimed in claim 2, wherein the integral capacitor is alternately charged and discharged by the output terminal of the comparator, to cause a voltage of the non-inverting input terminal is alternately higher and lower than a voltage of the inverting input terminal, thereby the output terminal generates and outputs the pulse signal which alternates between a high level voltage and a low level voltage.

4. The indicator light control circuit as claimed in claim 2, wherein the comparator further comprising a positive power terminal and a negative power terminal, the positive power terminal is electronically connected to the power supply, the negative power terminal is grounded.

5. The indicator light control circuit as claimed in claim 2, wherein the bias circuit further comprising a voltage dividing resistor, the digital potentiometer and the voltage dividing resistor are electronically connected in series between the power supply and ground, a node between the digital potentiometer and the voltage dividing resistor is electronically connected to the non-inverting input terminal.

6. The indicator light control circuit as claimed in claim 1, wherein further comprising a power supply and a electronic switch electronically connected to the pulse signal generating circuit, the indicator light is a LED, an anode of the LED is electronically connected to the power supply, a cathode of the LED is grounded via the electronic switch, the electronic switch is alternately turned on and off under the control of the pulse signal, to turn on or off a current path between the power supply and the indicator light, thereby alternately providing or not providing power to make the indicator light flash.

7. The indicator light control circuit as claimed in claim 6, wherein the electronic switch is a N channel MOSFET, a gate of the N channel MOSFET is electronically connected to a output terminal of the pulse signal generating circuit, a drain of the N channel MOSFET is electronically connected to the cathode of the LED, and a source of the N channel MOSFET is grounded.

8. The indicator light control circuit as claimed in claim 6, wherein the electronic switch is a NPN type BJT, a base of the NPN type BJT is electronically connected to a output terminal of the pulse signal generating circuit, a collector of the NPN type BJT is electronically connected to the cathode of the LED, and an emitter of the NPN type BJT is grounded.

9. An indicator light control circuit for controlling a single indicator light to indicate a high or low link speed of a network connection, comprising:
a pulse signal generating circuit for generating a pulse signal;
a bias circuit comprising a digital potentiometer electronically connected to the pulse signal generating circuit;
a controller electronically connected to the digital potentiometer, the controller adjusting an effective resistance of the digital potentiometer connected to the pulse signal generating circuit according to different link speeds being experienced in the network connection, to adjust a duty cycle of the pulse signal correspondingly, thereby changing a on-time and off-time of the indicator light.

10. The indicator light control circuit as claimed in claim 9, further comprising a power supply, wherein the pulse signal generating circuit comprising a comparator, a integral resistor, a integral capacitor and a feedback resistor, the comparator comprising an inverting input terminal, a non-inverting input terminal, and an output terminal, the integral resistor is electronically connected between the output terminal and the inverting input terminal of the comparator, the integral capacitor is electronically connected between ground and a node between the integral resistor and the inverting input terminal, the feedback resistor is electronically connected between the non-inverting input terminal and the output terminal, the non-inverting input terminal is further electronically connected to the power supply via the bias circuit.

11. The indicator light control circuit as claimed in claim 10, wherein the integral capacitor is alternately charged and discharged by the output terminal of the comparator, to cause a voltage of the non-inverting input terminal is alternately higher and lower than a voltage of the inverting input terminal, thereby the output terminal generates and outputs the pulse signal which alternates between a high level voltage and a low level voltage.

12. The indicator light control circuit as claimed in claim 10, wherein the comparator further comprising a positive power terminal and a negative power terminal, the positive power terminal is electronically connected to the power supply, the negative power terminal is grounded.

13. The indicator light control circuit as claimed in claim 10, wherein the bias circuit further comprising a voltage dividing resistor, the digital potentiometer and the voltage dividing resistor are electronically connected in series between the power supply and ground, a node between the digital potentiometer and the voltage dividing resistor is electronically connected to the non-inverting input terminal.

14. The indicator light control circuit as claimed in claim 9, wherein further comprising a power supply and a electronic switch electronically connected to the pulse signal generating circuit, the indicator light is a LED, an anode of the LED is electronically connected to the power supply, a cathode of the LED is grounded via the electronic switch, the electronic switch is alternately turned on and off under the control of the pulse signal, to turn on or off a current path between the power supply and the indicator light, thereby alternately activating or deactivating the indicator light to make the indicator light flash.

15. The indicator light control circuit as claimed in claim 14, wherein the electronic switch is a N channel MOSFET, a gate of the N channel MOSFET is electronically connected to a output terminal of the pulse signal generating circuit, a drain of the N channel MOSFET is electronically connected to the cathode of the LED, and a source of the N channel MOSFET is grounded.

16. The indicator light control circuit as claimed in claim 14, wherein the electronic switch is a NPN type BJT, a base of the NPN type BJT is electronically connected to a output terminal of the pulse signal generating circuit, a collector of the NPN type BJT is electronically connected to the cathode of the LED, and an emitter of the NPN type BJT is grounded.
